(19) United States
(12) Patent Application Publication
(10) Pub. No.: US 2015/0310887 A1
(43) Pub. Date: Oct. 29, 2015

(54) AUDIO AND VIDEO RECORDING SYSTEM HAVING WIRELESS COMMUNICATION AND METHOD OF OPERATING THE SAME

(71) Applicant: Hui-Hu Liang, CHANGHUA COUNTY (TW)

(72) Inventor: Tsao-Hung WANG, CHANGHUA COUNTY (TW)

(21) Appl. No.: 14/450,873

(22) Filed: Aug. 4, 2014

(30) Foreign Application Priority Data
Apr. 29, 2014 (TW) 103115401

(51) Int. Cl. G11B 20/00; H04N 9/802; H04N 9/80

(52) U.S. Cl. CPC G11B 20/00007; H04N 9/80; H04N 9/802; G11B 2020/00014; G11B 2020/00072

(57) ABSTRACT

An audio and video recording system having wireless communication includes an audio receiver and a video device for receiving and converting external audio and video into audio and video signals; a playback device for playing the audio and video signals; a wireless communication module for transmitting or receiving the audio and video signals via wireless transmission; when a command is issued through an interface unit, a multimedia processor compresses or decompresses the audio or video signal according to the command and then stores it into a storage device; a system processor executes an audio and video function and a communication function according to the command; and a RAM and a ROM store data and program codes required for the command and for executing the command. Therefore, audio and video contents of a dialogue can be merged for playback and wireless transmission to other device.

### BACKGROUND OF THE INVENTION

1. Field of the Invention

The present invention relates generally to an audio and video recording system and more particularly, to an audio and video recording system having wireless communication and a method operating the audio and video recording system.

2. Description of the Related Art

A conventional walkie-talkie does not lead to any cost and is very convenient for short-distance communication, so it is very common that the walkie-talkie is popularly applied to the communication between car or motorcycle drivers or between the rescue personnel or between engineering personnel. However, such walkie-talkie is usually an independent system without any other function or signal transmission tool. For example, the system of the conventional walkie-talkie can do nothing but transmit or receive audio signals without recording any on-site video signal, so it needs to take more time for communication. Besides, radio waves are the only means for reception and transmission between the systems of the conventional wireless walkie-talkies, thus limiting the format of the signal. Therefore, the conventional walkie-talkie is defective to need further improvement.

### SUMMARY OF THE INVENTION

The primary objective of the present invention is to provide an audio and video recording system having wireless communication.

The foregoing objective of the present invention is attained by the audio and video recording system formed of an audio receiver, a video device, a playback device, a wireless communication module, an interface unit, a multi-media processor, a storage device, a system processor, a random access memory (RAM), and a read-only memory (ROM). The audio receiver can receive an external audio source and convert it into an audio signal. The video device can receive an external video and convert it into a video signal. The playback device can play the audio signal and the video signal. The wireless communication module can transmit the audio signal or the video signal via wireless transmission. The interface unit can receive a command from a user. According to the command, the multimedia processor can convert the audio signal and the video signal into an audio file and a video file, respectively, via compression or convert the audio file and the video file into the audio signal and the video file, respectively, via decompression. The storage device can store the audio and video files. The system processor can execute a function of audio and video playback and recording and a communication function. The RAM can store data required for the system processor to execute the command. The ROM can store at least one program code required for execution of the command.

In a preferred embodiment, the wireless communication module is a Bluetooth™ module.

In a preferred embodiment, the interface unit is a voice-controlled device.

In a preferred embodiment, the multimedia processor includes an audio signal processor and a video signal processor. The audio signal processor and the video signal processor can convert the audio signal and the video signal into the audio file and the video file, respectively, via compression or convert the audio file and the video file into the audio signal and the video signal, respectively, via decompression.

In a preferred embodiment, the audio and video recording system further includes a wireless signal receiver for emitting or receiving radio waves

In a preferred embodiment, the wireless communication module can be linked with a wireless communication device according to the command.

In a preferred embodiment, the wireless communication device is a smart phone or a Bluetooth™ earphone.

In a preferred embodiment, the audio and video recording system having wireless communication can transmit the audio signal or the video signal to another audio and video recording system having wireless communication via the wireless communication module or receive the audio signal or the video signal from another audio and video recording system having wireless communication.

The secondary objective of the present invention is to provide a method of operating the audio and video recording system having wireless communication. The method includes the steps of switching on the video recording system; activating a function of audio and video recording to make the audio receiver and the video device generate an audio signal and a video signal, respectively; activating a function of wireless communication to make the video recording system linked with a wireless communication device or another audio and video recording system having wireless communication; via the interface unit, identifying whether the audio recording function is activated; embedding the audio signal into the video signal via the system processor if the function of audio recording is activated, and vice versa; storing the audio signal and the video signal into the storage device by means of the system processor; and switching off the audio and video recording system via the interface unit.

In light of the structure mentioned above, the audio and video recording system of the present invention can allow the user to proceed with wireless dialogue, in the process of which, the user can record and integrate the audio dialogue into the video dialogue and further transmit it to other device via wireless transmission to enhance the practicability of the audio and video recording system of the present invention.

### BRIEF DESCRIPTION OF THE DRAWINGS

FIG. 1 is a block diagram of the audio and video recording system having wireless communication in accordance with a preferred embodiment of the present invention.

FIG. 2 is a flow chart of the method of operating video recording system in accordance with another preferred embodiment of the present invention.

### DETAILED DESCRIPTION OF PREFERRED EMBODIMENTS

Structural features and desired effects of the present invention will become more fully understood by reference to preferred embodiments given hereunder. However, it is to be understood that these embodiments are given by way of illustration only, thus being not limitative of the claim scope of the present invention.

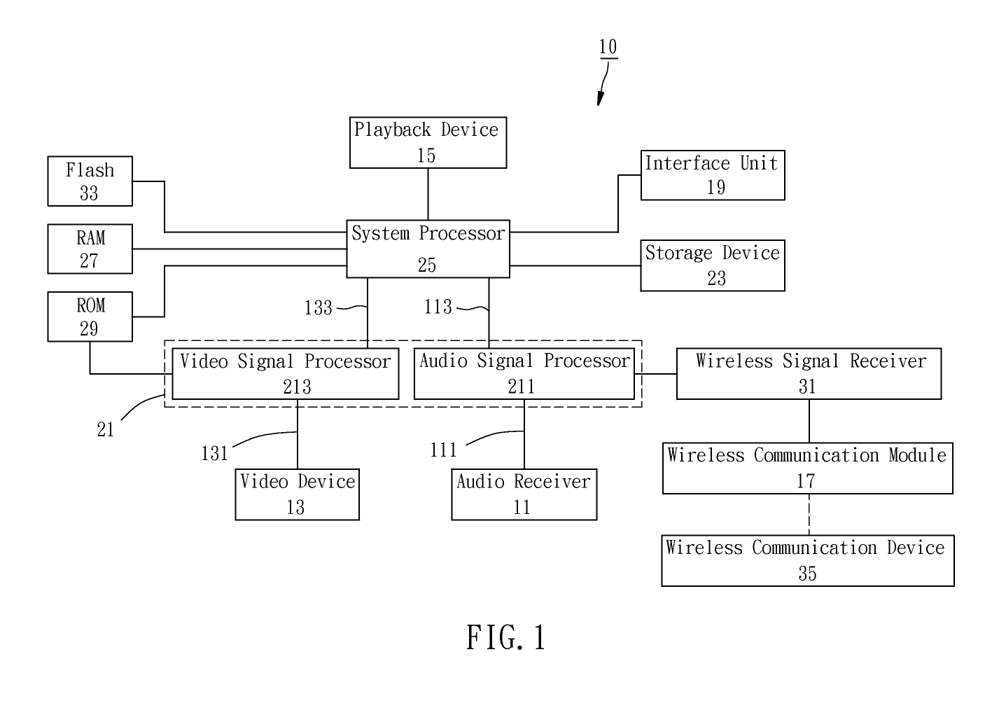

Referring to FIG. 1, an audio and video recording system 10 having wireless communication in accordance with a preferred embodiment of the present invention is formed of an audio receiver 11, a video device 13, a playback device 15, a wireless communication module 17, an interface unit 19, a multimedia processor, 21 a storage device 23, a system processor 25, a RAM 27, a ROM 29, a wireless signal receiver 31, and a flash memory 33. The system processor 25 can control and coordinate other components and execute functions of audio and video recording and playback, transmission of audio and video signals, and audio and video integration. The wireless signal receiver 31 can emit or receive radio waves. The flash memory 33 includes at least one prewritten software, firmware, or algorithm The detailed descriptions and operations of these elements as well as their interrelations are recited in the respective paragraphs as follows.

The audio receiver 11 can receive an external audio source and convert it into an audio signal 111. The video device 13 can receive an external video and convert it into a video signal 131. The audio signal 111 and the video signal 131 can be played through the playback device 15. In the preferred embodiment of the present invention, the audio receiver 11 is a microphone, the video device 13 is a video sensor, and the playback device 15 includes output devices like a display device and a megaphone.

The wireless communication module 17 is a Bluetooth module and can be linked with a wireless communication device 35 according to a user's command. Further, the wireless communication module 17 can transmit or receive the audio signal 111 or the video signal 131 via wireless transmission. The wireless communication device 35 can be a smart phone, a Bluetooth™ earphone, or an electronic product having Bluetooth™. The interface unit 19 is a control panel or a voice-controlled device. If the interface unit 19 is a control panel, the user can touch the control panel to issue a command. If the interface unit 19 is a voice-controlled device, the user can issue a command by his or her voice. In this way, the user does not need to manually operate the interface unit 19, while driving a car, to enhance the driving safety.

The multimedia processor 21 can convert the audio and video signals 111 and 131 into the audio and video files, respectively, via compression or convert the audio and video files into the audio and video signals 111 and 131, respectively, via decompression according to the user's command. In this embodiment, the multimedia processor 21 includes an audio signal processor 211 and a video signal processor 213. The audio signal processor 211 can convert the audio signal 111 into an audio file 113 via compression or convert the audio file 113 into the audio signal 111 via decompression according to the command. The video signal processor 213 can convert the video signal 131 into a video file 133 via compression or convert the video file 133 into the video file 131 via decompression. The aforesaid compression and decompression are based on the popular multimedia compression standard, such as moving picture exports group (MPEG) and International Telecommunication Union telecommunication standardization sector (ITU-T).

The storage device 23 can store the audio file 113 and the video file 133. In this preferred embodiment, the storage device 13 is a hard disk drive (not shown) or a memory card (not shown). To have effective access to files, the storage device 12 includes a built-in file system supporting a variety of multimedia file formats, such as audio video interleave (AVI). The RAM 27 can store data required for the system processor 25 to execute the command. The ROM 29 can store at least one program code required for executing the command.

The system processor 25 can execute functions of audio and video recording and playback, communication, and audio embedment according to the user's command. As for the audio and video recording in the function of the audio and video recording and playback, the video signal processor 213 converts the video signal 131 provided by the video device 13 into the video file 133 via compression and then store it into the storage device 23; the audio signal processor 211 can convert the audio signal 111 provided by the audio receiver 11 into the audio file 113 via compression and then store it into the storage device 23. As for the audio and video playback in the function of the audio and video recording and playback, the video processor 213 and the audio processor 211 convert the video file 133 and the audio file 113 stored in the storage device 23 back into the video signal 131 and the audio signal 111, respectively, via decompression and then the playback device 15 plays the video signal 131 and the audio signal 111. The communication function is to transmit the audio signal 111 provided by the audio receiver 11 via the wireless communication module 17 or to play the audio signal 111 received by the wireless communication module 17 via the playback device 15. The function of the audio embedment allows the user to issue a command of audio recording to the interface unit 19, further the audio signal processor 211 applying audio processing to the dialogue recorded by the audio receiver 11 and then the system processor 25 merging the processed dialogue and the video processed via the video processor 213. On the contrary, if the user does not issue the command of the audio recording to the interface unit 19, the audio signal processor 211 will not execute the audio processing and meanwhile, the system processor 25 will not execute the function of audio embedment.

The audio and video recording system 10 of the present invention can be operated as recited hereinafter. For example, the audio and video recording system 10 can transmit the audio signal 111 or the video signal 131 to another recording system having wireless communication via the wireless communication module 17 or receive the audio signal 111 or the video signal 131 from another recording system having wireless communication; the audio and video recording system 10 can transmit the audio signal 111 or the video signal 131 to the wireless communication device 35 via the wireless communication module 17 or receive the audio signal 111 or the video signal 131 from wireless communication device 35.

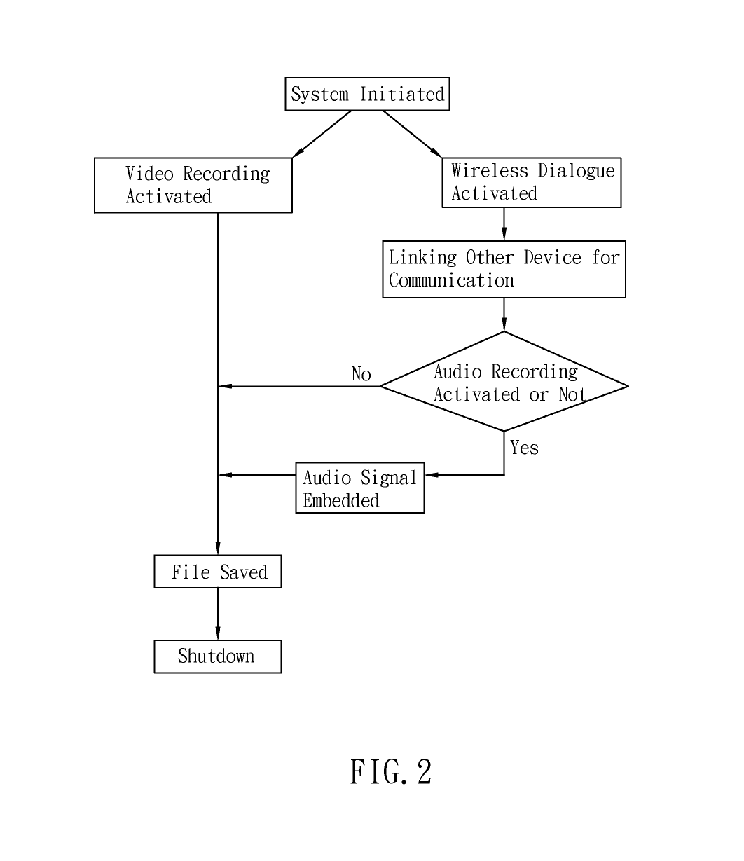

Referring to FIG. 2, a method of operating the audio and video recording system 10 having wireless communication in accordance with another preferred embodiment of the present invention includes the following steps.
1. Switch on the video recording system.
2. When the function of video recording is activated, the audio receiver 11 and the video device 13 can generate the audio signal 111 and the video signal 131.
3. When the function of wireless communication is activated, the audio and video recording system 10 is linked with the wireless communication device 35 via the wireless communication module 17 or linked with another video recording system having wireless communication.
4. Next, by means of the interface unit 19, the user can identify whether the function of audio recording is activated. If the function of audio recording is activated, the audio signal 111 will be embedded into the video signal 131 via the system processor 25. On the contrary, if the function of audio recording is not activated, the audio signal 111 will not be embedded into the video signal 131.
5. Further, the system processor 25 stores the audio signal 111 and the video signal 131 into the storage device 23 and finally the interface unit 19 switches off the video recording system 10.

In light of the steps mentioned above, the audio and video recording system 10 of the present invention can merge the audio content and the video content of the dialogue together and play the same. Furthermore, the audio and video recording system 10 can proceed with communication and signal transmission with other electronic products having Bluetooth™ via the wireless communication module 17.

What is claimed is:

1. An audio and video recording system having wireless communication, comprising:
an audio receiver for receiving an external audio source and converting it into an audio signal;
a video device for receiving an external video and converting it into a video signal;
a wireless communication module for transmitting the audio signal or the video signal via wireless transmission;
an interface unit for receiving a command from a user;
a multimedia processor for converting the audio signal and the video signal into an audio file and a video file, respectively, via compression, or converting the audio file and the video file into the audio signal and the video signal, respectively, via decompression according to the command;
a storage device for storing the audio file and the video file;
a system processor for executing a video recording function or a communication function according to the command;
a random access memory (RAM) for storing data required for the system processor to execute the command; and
a read-only memory (ROM) for storing at least one program code required for execution of the command.

2. The audio and video recording system as defined in claim 1, wherein the wireless communication module is a Bluetooth™ module.

3. The audio and video recording system as defined in claim 1, wherein the interface unit is a voice-controlled device.

4. The audio and video recording system as defined in claim 1, wherein the multimedia processor comprises an audio signal processor and a video signal processor for converting the audio signal and the video signal into the audio file and the video file, respectively, via compression or converting the audio file and the video file into the audio signal and the video signal, respectively, via decompression according to the command.

5. The audio and video recording system as defined in claim 1, wherein audio and video recording system further comprises a wireless signal receiver for emitting or receiving radio waves.

6. The audio and video recording system as defined in claim 5, wherein the wireless communication module is based on the command to be linked with a wireless communication device.

7. The audio and video recording system as defined in claim 6, wherein the wireless communication device is a smart phone or a Bluetooth™ earphone.

8. The audio and video recording system as defined in claim 1, wherein the wireless communication module transmits the audio signal or the video signal to another wireless communication system having wireless communication or receives the audio signal or the video signal from another wireless communication system having wireless.

9. The audio and video recording system as defined in claim 1, wherein the wireless communication module transmits the audio signal or the video signal to a wireless communication device or receives the audio signal or the video signal from the wireless communication device.

10. A method of operating the audio and video recording system having wireless communication includes steps of:
(1) switching on the audio and video recording system;
(2) activating on a function of video recording to make an audio receiver and an video device generate an audio signal or a video signal;
(3) activating a function of wireless communication to make the video recording system linked with a wireless communication device via a wireless communication module or linked with another audio and video recording system having wireless communication;
(4) via an interface unit, identifying whether the function of audio recording is activated; if the function of audio recording is activated, the audio signal will be embedded into the video signal via a system processor; if the function of audio recording is not activated, the audio signal will not be embedded into the video signal;
(5) storing the audio signal and the video signal into a storage device via the system processor; and
(6) switching off the audio and video recording system via the interface unit.
